(19) United States
(12) Patent Application Publication
(10) Pub. No.: US 2023/0115805 A1
(43) Pub. Date: Apr. 13, 2023

(54) FRAMEWORK FOR IMPLEMENTING PROCESS APPS FOR PROCESS MINING

(71) Applicant: UiPath, Inc., New York, NY (US)

(72) Inventors: Matthew VANDERZEE, Sammamish, WA (US); Céline Verhoef, Nuenen (NL); Johannes Wilhelmus Maria Selman, Eindhoven (NL); Sven Cornelius Hubertus Bego, Veldhoven (NL); Martijn Wilhelmus Henricus Wijffelaars, Eindhoven (NL); Kosmas Wilhelmus Hatzidimitris, Vught (NL)

(73) Assignee: UiPath, Inc., New York, NY (US)

(21) Appl. No.: 17/450,170

(22) Filed: Oct. 7, 2021

(51) Int. Cl. G06F 16/2458; G06F 16/25; G06F 16/248; G06F 8/65

(52) U.S. Cl. CPC G06F 16/2465; G06F 16/254; G06F 16/248; G06F 8/65; G06F 2216/03

(57) ABSTRACT

Systems and methods for performing process mining are provided. Data from one or more source systems is extracted by a data connector of a process app. The extracted data is transformed into a normalized data model by transforms of the process app. One or more process mining algorithms of the process app are applied to the normalized data. Results of the one or more process mining algorithms are presented to a user via a user interface of the process app.

### TECHNICAL FIELD

The present invention relates generally to process mining, and more particularly to a framework for implementing process apps for process mining.

### BACKGROUND

In process mining, applications are developed for applying certain process mining algorithms and presenting results of the process mining algorithms. Such applications are typically independently developed for applying the process mining algorithms and do not provide for a standardized framework for developing the applications. The independent development of such applications is inefficient and may result in lengthy development and deployment times.

### BRIEF SUMMARY OF THE INVENTION

In accordance with one or more embodiments, a framework for implementing process apps for process mining is provided. The framework provides a standardized development environment that reduces development and deployment times of process apps.

In one embodiment, systems and methods for performing process mining are provided. Data from one or more source systems is extracted by a data connector of a process app. The extracted data is transformed into a normalized data model by transforms of the process app. One or more process mining algorithms of the process app are applied to the normalized data. Results of the one or more process mining algorithms are presented to a user via a user interface of the process app. In one embodiment, the extracted data comprises data relating to an RPA (robotic process automation) workflow.

In one embodiment, the extracted data is stored as one or more raw tables. In another embodiment, the normalized data model is stored as one or more normalized tables. The normalized data model may be in a format defined by a data model associated with the one or more process mining algorithms. The one or more process mining algorithms may be determined based on the process app. Analytical measures determined based on the process app may be presented.

In one embodiment, a configuration of the process app is stored as a computer-readable representation for execution and transmission. The process app may comprise test data to enable the process app to be tested where it is instantiated.

In one embodiment, a configuration of the process app is based on an existing process app. The process app may be upgraded based on changes to the existing process app.

In one embodiment, creation of the process app may be facilitated via a process app development framework comprising a set of tools, processes, and components for developing, building, and testing the process app. At least one of the data connector, the transforms, the one or more process mining algorithms, and the user interface may be automatically tested by the process app development framework.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process mining workflow performed utilizing a process app, according to an embodiment of the invention;

FIG. 2 shows a method for performing a process mining workflow performed utilizing a process app, according to an embodiment of the invention; and

FIG. 3 is a block diagram of a computing system, which may be used to implemented embodiments of the invention.

### DETAILED DESCRIPTION

Embodiments described herein provide for the performance of process mining using process apps. As used herein, a process app is an application tuned for specific processes or workflows to apply and present results of one or more process mining algorithms. In accordance with embodiments described herein, a process app comprises: 1) a data connector, 2) transforms, 3) process mining algorithms, and 4) a user interface comprising one or more dashboards. Exemplary process apps include order-to-cash (O2C) process apps, purchase-to-pay (P2P) process apps, etc. Each process app applies different process mining algorithms and generates a user interface for presenting various analytics for the specific processes or workflows.

Each process app defines a normalized data model that embodies the data entities necessary to support mining of that process. This normalized data model is typically a database table or set of tables that define a relational mapping of entities involved in a process. For example, in P2P processes, typical entities are Vendor, Invoice, Order, and Payment. In addition to tables for the key entities, the data model typically includes supporting metadata tables, join tables, and other data.

[symbol]

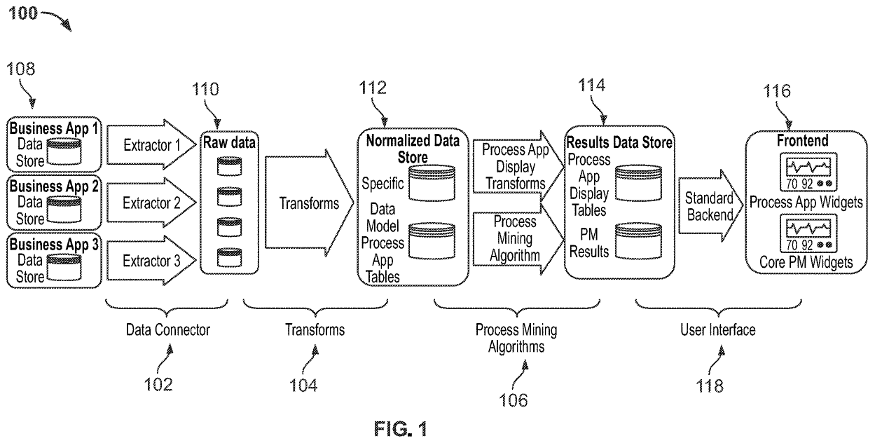

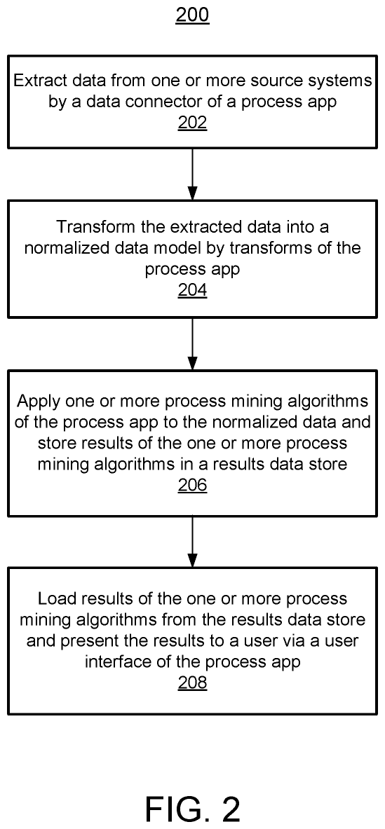

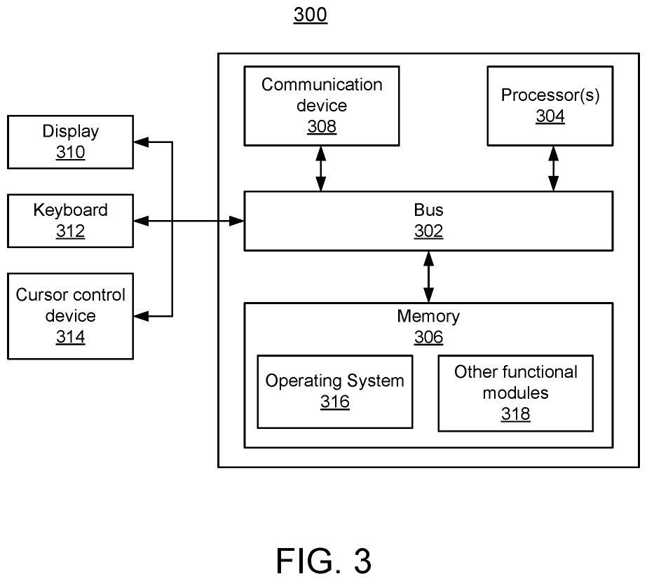

FIG. 1 shows an illustrative process mining workflow 100, in accordance with one or more embodiments. Process mining workflow 100 is performed utilizing a process app comprising data connector 102, process mining algorithms 104, dashboard 106, and user interface 118. FIG. 2 shows a method 200 for performing a process mining workflow utilizing a process app, in accordance with one or more embodiments. FIG. 1 and FIG. 2 will be described together. The steps of method 200 may be performed by one or more suitable computing devices, such as, e.g., computing system 300 of FIG. 3.

At step 202 of FIG. 2, data from one or more source systems is extracted by a data connector of a process app. For example, as shown in process mining workflow 100 of FIG. 1, raw data 110 is extracted from source systems 108 by data connector 102. Source systems 108 are shown in process mining workflow 100 as data stores of business apps.

In one embodiment, the extracted data is data relating to a process or workflow stored by the source systems. For example, the extracted data may comprise data relating to an RPA (robotic process automation) process or workflow. However, the processes or workflows may be any suitable processes or workflows. In one embodiment, the extracted data is stored as one or more raw tables. However, the extracted data may be stored in any suitable format. In one embodiment, the data connector incrementally extracts the data from the source systems to minimize the amount of external system access and filters the extracted data to reduce the total data volume.

In one embodiment, the data connector is encapsulated in a single repository having a predefined structure to facilitate development, testing, and deployment. For example, the repository may comprise folders and/or files for one or more of: pipeline configurations, schema, data, test, documents, process app, configuration, and variables. The data connector may be built (e.g., by forking a repository of an existing data connector) or may be an off-the-shelf data connector. While the data connector is a part of the process app, it can be executed as an independent component for development, testing, and manual usage.

At step 204 of FIG. 2, the extracted data is transformed into a normalized data model by transforms of the process app. For example, as shown in process mining workflow 100 of FIG. 1, raw data 110 is transformed into normalized data store 112 by transforms 104. The transforms perform data operations (such as, e.g., aggregate, join, filtering, and mapping) on the extracted data to generate the normalized data. The normalized data model embodies the data entities necessary to support mining that process, as noted above. The normalized data model is in a format defined by a data model associated with process mining algorithms to be applied (at step 206). In one embodiment, the normalized data model comprises a normalized table. However, the normalized data model may be in any other suitable format. Each process app defines a set of transforms that convert raw data from each relevant connector into the process app's normalized data model. Additionally, users of a process app might edit or add transforms in specific cases, when the data should be transformed differently based on need.

In one example, an SAP (systems applications and products) P2P process app is built to extract SAP purchase-to-pay data, but specific customers may need to change the transforms if they have custom data with SAP, which happens relatively frequently. In accordance with embodiments described herein, the SAP P2P process app can not only be built, but also customized for specific situations. The framework provided herein ensures that the customizations are forked from the original, and thus can be maintained.

At step 206 of FIG. 2, one or more process mining algorithms are applied to the normalized data and results of the one or more process mining algorithms are stored in a results data store. The process mining algorithms may include any suitable process mining algorithm (e.g., conformance checking). For example, as shown in process mining workflow 100 of FIG. 1, one or more process mining algorithms 106 are applied to normalized data store 112 to generate results data store 114. Additionally, normalized data may be processed to yield additional data to facilitate displaying process mining results. This additional data may support more performant user interface display or additional context for the process mining user.

At step 208 of FIG. 2, results of the one or more process mining algorithms are loaded from the results data store and the results are presented to the user via a user interface. For example, as shown in process mining workflow 100 of FIG. 1, user interface 118 of frontend 116 loads results from results data store 114, which are presented to the user by one or more widgets. Examples of widgets common to Process Mining are a process graph, filter controls, key performance indicator charts, and business details.

The process mining algorithms may comprise any suitable process mining algorithm. The results of the process mining algorithms are presented via one or more user interfaces (e.g., dashboards) to convey various insights on the extracted data. In one embodiment, certain analytical measures, which are determined based on the process app, are presented based on the results of the process mining algorithms. The process mining algorithms and user interfaces are determined based on the process app.

In one embodiment, the dashboard is encapsulated in a single repository having a predefined structure to facilitate development, testing, and deployment. For example, the repository may comprise folders and/or files for one or more of: schema, user interface, and data. The dashboard may be built (e.g., by forking a repository of an existing dashboard) or may be an existing generic dashboard.

In accordance with embodiments described herein, a framework for implementing the process app is provided. This framework provides for a methodology, tools, and normalization that facilitate the authoring, building, and testing of the process app and allows the process app to be built in a standardized and maintainable fashion. This framework decouples the stages of process app development and implementation to thereby enable each stage to be built, tested, and published independently, while also providing for a standardized and rigid development environment. Advantageously, this framework reduces the development and deployment time for the process app. Similar to how software development tools like Visual Studio supplement the authoring of software, the process app development framework supplements the development of the process app.

This framework also provides a customization layer for the process app. The process app standardizes the application of process mining to a particular process area and underlying business systems, but at times may need to be customized for specific use cases. In this regard, the framework simplifies the customization of the process app's data connectors, transforms, data model, and user interface.

In one embodiment, the process app development framework comprises a user interface for supporting the development of the process app, as well as a set of tools, processes, and components. The user interface comprises a configuring connectors dashboard, an authoring transforms dashboard, and a designing user interface dashboard. In one embodiment, the data connector, transforms, process mining algorithms, and/or user interface may be automatically tested and the user interface may indicate to the process app developer when there are parts of the process app that aren't functioning correctly. For example, if any of the tests have failed, an error message is displayed to the user. The set of tools, processes, and components are for developing, building, and testing the process app. For example, data connectors can be tested with test data packaged with the process app or by executing the transforms and validating the resulting data against an expected outcome. Similarly, the user interface can be visualized with test data to ensure the correct dashboard layout.

In one embodiment, the process app development framework facilitates the creation of new process apps based on existing process apps by inheriting configurations from the existing process apps using an inheritance model. For example, if a user has a custom invoicing process, the user can download an existing process app for invoicing, and then make changes to match the custom invoicing process. In one embodiment, if a process app has inherited from a base process app, and the base process app has been improved, the process app development framework supports propagating those improvements to the inheriting process app.

Once the process app is created, the configuration of the process app may be stored in a computer-readable representation for execution and/or transmission. The process app is stored in a data structure to include test data to enable the process app to be tested wherever it is instantiated.

FIG. 3 is a block diagram illustrating a computing system 300 configured to execute the methods, workflows, and processes described herein, including method 200 of FIG. 2, according to an embodiment of the present invention. In some embodiments, computing system 300 may be one or more of the computing systems depicted and/or described herein. Computing system 300 includes a bus 302 or other communication mechanism for communicating information, and processor(s) 304 coupled to bus 302 for processing information. Processor(s) 304 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 304 may also have multiple processing cores, and at least some of the cores may be configured to perform specific functions. Multi-parallel processing may be used in some embodiments.

Computing system 300 further includes a memory 306 for storing information and instructions to be executed by processor(s) 304. Memory 306 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 304 and may include volatile media, non-volatile media, or both. The media may also be removable, non-removable, or both.

Additionally, computing system 300 includes a communication device 308, such as a transceiver, to provide access to a communications network via a wireless and/or wired connection according to any currently existing or future-implemented communications standard and/or protocol.

Processor(s) 304 are further coupled via bus 302 to a display 310 that is suitable for displaying information to a user. Display 310 may also be configured as a touch display and/or any suitable haptic I/O device.

A keyboard 312 and a cursor control device 314, such as a computer mouse, a touchpad, etc., are further coupled to bus 302 to enable a user to interface with computing system. However, in certain embodiments, a physical keyboard and mouse may not be present, and the user may interact with the device solely through display 310 and/or a touchpad (not shown). Any type and combination of input devices may be used as a matter of design choice. In certain embodiments, no physical input device and/or display is present. For instance, the user may interact with computing system 300 remotely via another computing system in communication therewith, or computing system 300 may operate autonomously.

Memory 306 stores software modules that provide functionality when executed by processor(s) 304. The modules include an operating system 316 for computing system 300 and one or more additional functional modules 318 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
extracting data from one or more source systems by a data connector of a process app;
transforming the extracted data into a normalized data model by transforms of the process app;
applying one or more process mining algorithms of the process app to the normalized data; and
presenting results of the one or more process mining algorithms to a user via a user interface of the process app.

2. The computer-implemented method of claim 1, wherein the extracted data is stored as one or more raw tables.

3. The computer-implemented method of claim 1, wherein the normalized data model is stored as one or more normalized tables.

4. The computer-implemented method of claim 1, wherein the normalized data model is in a format defined by a data model associated with the one or more process mining algorithms.

5. The computer-implemented method of claim 1, wherein the one or more process mining algorithms are determined based on the process app.

6. The computer-implemented method of claim 1, wherein presenting results of the one or more process mining algorithms to a user via a user interface of the process app comprises:
presenting analytical measures determined based on the process app.

7. The computer-implemented method of claim 1, wherein a configuration of the process app is stored as a computer-readable representation for execution and transmission.

8. The computer-implemented method of claim 1, wherein the process app comprises test data to enable the process app to be tested where it is instantiated.

9. The computer-implemented method of claim 1, wherein a configuration of the process app is based on an existing process app.

10. The computer-implemented method of claim 9, further comprising:
upgrading the process app based on changes to the existing process app.

11. The computer-implemented method of claim 1, further comprising:
facilitating creation of the process app via a process app development framework comprising a set of tools, processes, and components for developing, building, and testing the process app.

12. The computer-implemented method of claim 11, further comprising:
automatically testing at least one of the data connector, the transforms, the one or more process mining algorithms, and the user interface by the process app development framework.

13. The computer-implemented method of claim 1, wherein the extracted data comprises data relating to an RPA (robotic process automation) workflow.

14. An apparatus comprising:
a memory storing computer program instructions; and
at least one processor configured to execute the computer program instructions, the computer program instructions configured to cause the at least one processor to perform operations of:
extracting data from one or more source systems by a data connector of a process app;
transforming the extracted data into a normalized data model by transforms of the process app;
applying one or more process mining algorithms of the process app to the normalized data; and
presenting results of the one or more process mining algorithms to a user via a user interface of the process app.

15. The apparatus of claim 14, wherein the extracted data is stored as one or more raw tables.

16. The apparatus of claim 14, wherein the normalized data model is stored as one or more normalized tables.

17. The apparatus of claim 14, wherein the normalized data model is in a format defined by a data model associated with the one or more process mining algorithms.

18. The apparatus of claim 14, wherein the one or more process mining algorithms are determined based on the process app.

19. The apparatus of claim 14, wherein presenting results of the one or more process mining algorithms to a user via a user interface of the process app comprises:
presenting analytical measures determined based on the process app.

20. The apparatus of claim 14, wherein a configuration of the process app is stored as a computer-readable representation for execution and transmission.

21. The apparatus of claim 14, wherein the process app comprises test data to enable the process app to be tested where it is instantiated.

22. The apparatus of claim 14, wherein a configuration of the process app is based on an existing process app.

23. The apparatus of claim 22, the operations further comprising:
upgrading the process app based on changes to the existing process app.

24. The apparatus of claim 14, the operations further comprising:
facilitating creation of the process app via a process app development framework comprising a set of tools, processes, and components for developing, building, and testing the process app.

25. The apparatus of claim 24, the operations further comprising:
automatically testing at least one of the data connector, the transforms, the one or more process mining algorithms, and the user interface by the process app development framework.

26. The apparatus of claim 14, wherein the extracted data comprises data relating to an RPA (robotic process automation) workflow.

27. A non-transitory computer-readable medium storing computer program instructions, the computer program instructions, when executed on at least one processor, cause the at least one processor to perform operations comprising:
extracting data from one or more source systems by a data connector of a process app;
transforming the extracted data into a normalized data model by transforms of the process app;
applying one or more process mining algorithms of the process app to the normalized data; and
presenting results of the one or more process mining algorithms to a user via a user interface of the process app.

28. The non-transitory computer-readable medium of claim 27, wherein the extracted data is stored as one or more raw tables.

29. The non-transitory computer-readable medium of claim 27, wherein the normalized data model is stored as one or more normalized tables.

30. The non-transitory computer-readable medium of claim 27, wherein the normalized data model is in a format defined by a data model associated with the one or more process mining algorithms.

31. The non-transitory computer-readable medium of claim 27, wherein the one or more process mining algorithms are determined based on the process app.

32. The non-transitory computer-readable medium of claim 27, wherein presenting results of the one or more process mining algorithms to a user via a user interface of the process app comprises:
presenting analytical measures determined based on the process app.

33. The non-transitory computer-readable medium of claim 27, wherein a configuration of the process app is stored as a computer-readable representation for execution and transmission.

34. The non-transitory computer-readable medium of claim 27, wherein the process app comprises test data to enable the process app to be tested where it is instantiated.

35. The non-transitory computer-readable medium of claim 27, wherein a configuration of the process app is based on an existing process app.

36. The non-transitory computer-readable medium of claim 35, further comprising:
upgrading the process app based on changes to the existing process app.

37. The non-transitory computer-readable medium of claim 27, the operations further comprising:
facilitating creation of the process app via a process app development framework comprising a set of tools, processes, and components for developing, building, and testing the process app.

38. The non-transitory computer-readable medium of claim 37, the operations further comprising:
automatically testing at least one of the data connector, the transforms, the one or more process mining algorithms, and the user interface by the process app development framework.

39. The non-transitory computer-readable medium of claim 27, wherein the extracted data comprises data relating to an RPA (robotic process automation) workflow.
